(19) United States
(12) Patent Application Publication
(10) Pub. No.: US 2026/0251995 A1
(43) Pub. Date: Aug. 27, 2026

(54) CLEANING APPARATUS AND IMAGE FORMING APPARATUS

(71) Applicant: KYOCERA Document Solutions Inc., Osaka (JP)

(72) Inventor: Rei Yamagishi, Osaka (JP)

(21) Appl. No.: 19/545,949

(22) Filed: Feb. 20, 2026

(30) Foreign Application Priority Data
Feb. 26, 2025 (JP) 2025-028769

(51) Int. Cl. G03G 15/02; G03G 21/16

(52) U.S. Cl. CPC G03G 15/0225; G03G 15/0291; G03G 21/1638; G03G 21/1647; G03G 2215/027; G03G 2221/1639; G03G 2221/1675; G03G 2221/1693

(57) ABSTRACT

A cleaning apparatus cleans a wire electrode of a charging apparatus that charges a surface of a photoconductor, where an electrostatic latent image is to be formed on the surface. The cleaning apparatus includes a cleaning member and an operation member. The cleaning member is brought into contact with the wire electrode to clean the wire electrode. The operation member is exposed to an exterior of an apparatus body of an image forming apparatus through an opening through which a photoconductor unit that includes the photoconductor and the charging apparatus is exposed externally. The operation member moves the cleaning member in a length direction of the wire electrode in response to being operated from the exterior.

### INCORPORATION BY REFERENCE

This application is based upon and claims the benefit of priority from the corresponding Japanese Patent Application No. 2025-028769 filed on February 26, 2025, the entire contents of which are incorporated herein by reference.

The present disclosure relates to a cleaning apparatus and an image forming apparatus.

### BACKGROUND

A cleaning member that cleans a wire electrode is known as a related technology. The wire electrode is included in a charging device, and produces a corona discharge in order to charge a photoconductor of an image forming apparatus. With respect to the related technology described above, the cleaning member is reciprocally moved in a longitudinal direction of an opening of the charging device when the wire electrode of the charging device is cleaned. This results in cleaning the wire electrode sandwiched between cleaning pads of the cleaning member.

### SUMMARY

A cleaning apparatus according to an aspect of the present disclosure cleans a wire electrode of a charging apparatus that charges a surface of a photoconductor, where an electrostatic latent image is to be formed on the surface. The cleaning apparatus includes a cleaning member and an operation member. The cleaning member is brought into contact with the wire electrode to clean the wire electrode. The operation member is exposed to an exterior of an apparatus body of an image forming apparatus in a state in which a cover that opens and closes an opening through which a photoconductor unit that includes the photoconductor and the charging apparatus is exposed externally. The operation member moves the cleaning member in a length direction of the wire electrode in response to being operated from the exterior.

An image forming apparatus according to another aspect of the present disclosure includes the cleaning apparatus described above, the apparatus body, the photoconductor unit, and the cover.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically illustrates a configuration of an image forming apparatus according to embodiments;

FIG. 2 is a schematic perspective view illustrating a state in which a cover of the image forming apparatus according to the embodiment is open;

FIG. 3 is a schematic perspective view illustrating configurations of a photoconductor unit and a cleaning apparatus according to the embodiments;

FIG. 4 is a schematic cross-sectional view illustrating the configurations of the photoconductor unit and the cleaning apparatus according to the embodiments;

FIG. 5 is a schematic perspective view illustrating the configuration of the cleaning apparatus according to the embodiments;

FIG. 6 is a schematic diagram used to describe movement of a restriction member according to the embodiments; and

FIG. 7 is a schematic diagram used to describe movement of the restriction member and a shutter according to the embodiments.

### DETAILED DESCRIPTION

Embodiments of the present disclosure will now be described below with reference to the accompanying drawings. The following embodiments are merely examples in which the present disclosure is embodied, and are not intended to limit the scope of the present disclosure.

### 1. Overall Configuration of Image Forming Apparatus

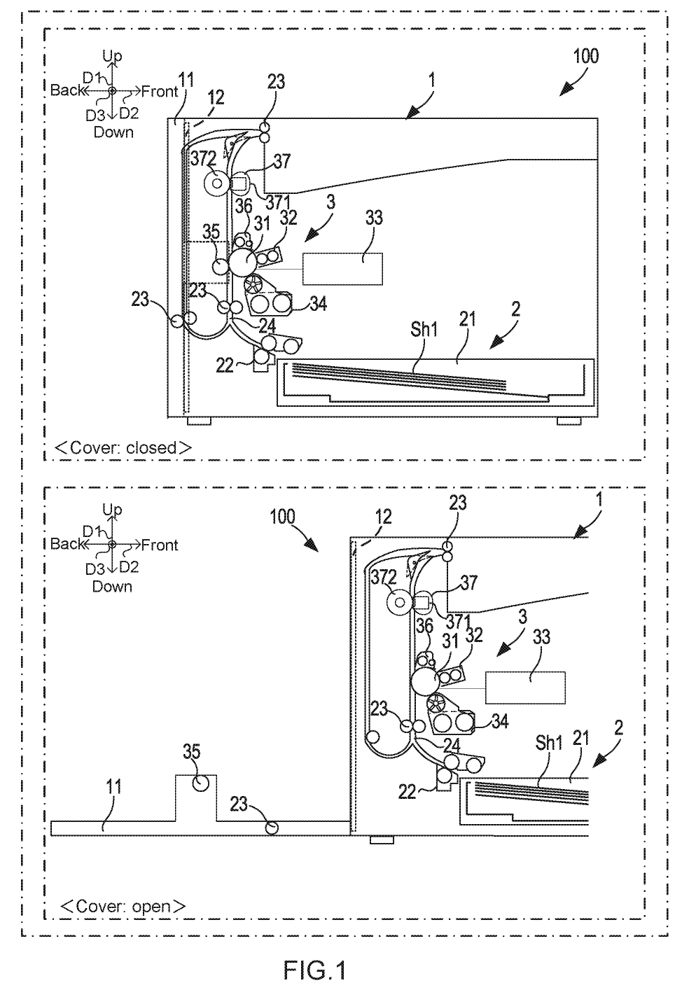

First, an overall configuration of an image forming apparatus 100 according to the present embodiment is described with reference to FIG. 1. In the following description, an orthogonal direction in a state (a state illustrated in FIG. 1) in which the image forming apparatus 100 is installed to be usable is defined as an up-and-down direction D1 for convenience of description. Further, a front-and-back direction D2 is defined, with a right side on the surface of the sheet of FIG. 1 being the front (a front side). Furthermore, a direction that is set for the image forming apparatus 100 of FIG. 1 and orthogonal to the surface of the sheet of FIG. 1 is defined as a right-and-left direction D3, and a front side on the surface of the sheet of FIG. 1 is defined as a left side. Note that the above-described definitions of the directions are not intended to limit a mode of use of the image forming apparatus 100.

For example, the image forming apparatus 100 according to the present embodiment is a printer that includes a printing function. Note that the image forming apparatus 100 is not limited to a printer, and may be a multifunctional device that includes a plurality of functions such as a printing function, a scanner function, a facsimile function, and a copying function.

As illustrated in FIG. 1, the image forming apparatus 100 includes an apparatus body 1, a sheet feeder 2, and an image forming section 3. The image forming apparatus 100 further includes an operation display section, a toner container, and a controller, although those are not illustrated. All of the sheet feeder 2, the image forming section 3, the operation display section, the toner container, and the controller are provided to the apparatus body 1.

The sheet feeder 2 supplies a sheet Sh1 to the image forming section 3. The sheet feeder 2 includes a sheet cassette 21, a sheet feeding apparatus 22, and a plurality of transportation rollers 23. The sheet feeding apparatus 22 feeds the sheets Sh1 in the sheet cassette 21 to a transportation path 24 one by one. The transportation path 24 is a passageway for the sheet Sh1. The plurality of transportation rollers 23 transports the sheet Sh1 along the transportation path 24.

On the basis of image data input by an information processing apparatus, such as a personal computer, that is external to the image forming apparatus 100, the image forming section 3 forms an image on the sheet Sh1 transported along the transportation path 24. In the present embodiment, the image forming section 3 includes, for example, a photoconductor 31, a charging apparatus 32, an optical scanning apparatus 33, a development apparatus 34, a transfer apparatus 35, a cleanup apparatus 36, and a fixation apparatus 37, and forms an image on the sheet Sh1 by electrophotography.

In the present embodiment, the image forming section 3 is configured to form a monochrome image using a color of K (black). Note that the image forming section 3 may be configured to form a full-color image using four colors that are C (cyan), M (magenta), Y (yellow), and K (black).

An electrostatic latent image is to be formed on a surface of the photoconductor 31. The photoconductor 31 is an example of an image carrier that is rotated in a state of carrying a toner image. The photoconductor 31 is also called a photoconductor drum.

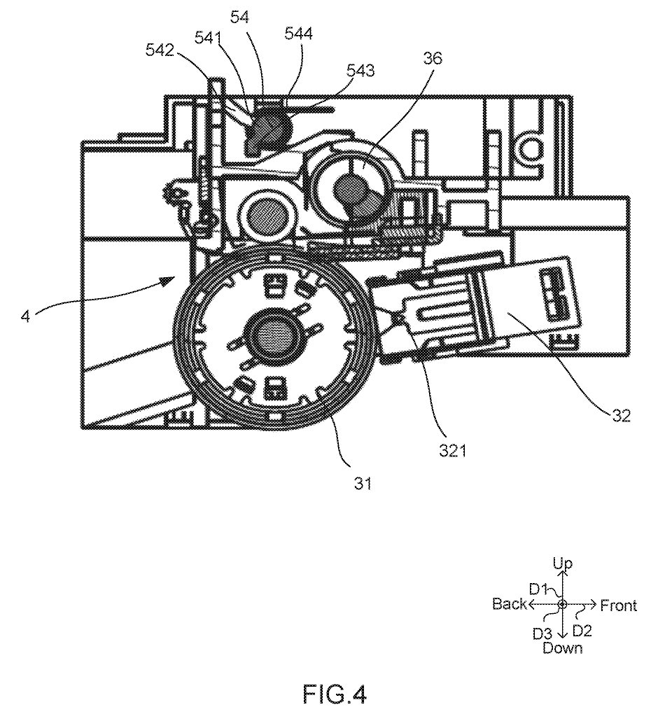

The charging apparatus 32 charges the surface of the photoconductor 31. Specifically, the charging apparatus 32 includes a wire electrode 321 that has a very small diameter and that is a metal line made of, for example, tungsten (refer to FIG. 4). In the charging apparatus 32, a high voltage is applied to the wire electrode 321 to produce a corona discharge. As a result, the charging apparatus 32 gives electric charges to the surface of the photoconductor 31 to charge the surface of the photoconductor 31. The charging apparatus 32 is, for example, a corotron charging device or a scorotron charging device.

The optical scanning apparatus 33 scans beam light onto the charged surface of the photoconductor 31. This results in the optical scanning apparatus 33 forming an electrostatic latent image on the surface of the photoconductor 31.

The development apparatus 34 supplies toner to the surface of the photoconductor 31 from the toner container, and develops the electrostatic latent image formed on the surface of the photoconductor 31 to form a toner image on the surface of the photoconductor 31.

The transfer apparatus 35 includes a transfer roller, and transfers, onto the sheet Sh1 transported along the transportation path 24, the toner image formed on the surface of the photoconductor 31.

The cleanup apparatus 36 removes waste toner from the surface of the photoconductor 31.

The fixation apparatus 37 fuses to fix, to the sheet Sh1, the toner image transferred onto the sheet Sh1. Specifically, the fixation apparatus 37 includes a heater, a fixation roller 371, and a pressure roller 372. Further, the fixation apparatus 37 heats, using the heater and the fixation roller 371, the toner image transferred onto the sheet Sh1, and applies pressure to the sheet Sh1 using the pressure roller 372 to fix the toner image to the sheet Sh1.

The operation display section is a user interface in the image forming apparatus 100. The operation display section includes a display section, such as a liquid crystal display, that displays thereon various information in response to control instructions being given by the controller, and an operation section, such as a switch or a touchscreen, with which various information is input to the controller in response to the operation section being operated by a user.

The controller performs overall control on the image forming apparatus 100. The controller primarily includes a computer system including at least one processor and at least one memory. In the image forming apparatus 100, functions of the controller are provided by the at least one processor executing a program. The program may be recorded on the at least one memory in advance, or may be provided through a telecommunications line such as the Internet. Alternatively, the program may be provided by being recorded on a non-transitory recording medium, such as a memory card or an optical disc, that is readable by a computer system. The at least one processor includes at least one electronic circuit including a semiconductor integrated circuit. Further, a computer system according to the present disclosure includes a microcontroller including at least one processor and at least one memory. The controller may be a controller that is provided independently of a primary controller that performs overall control on the image forming apparatus 100.

The image forming apparatus 100 further includes, for example, a storage, a communication section, and a power supply section. The storage includes at least one nonvolatile memory, and has stored therein information regarding, for example, a control program used to cause the controller to perform various processes. The communication section is an interface used to perform data communication between the image forming apparatus 100 and an external apparatus connected through a communication network such as the Internet or a local area network (LAN). The power supply section is a power supply circuit that generates (outputs) power used to operate the image forming apparatus 100.

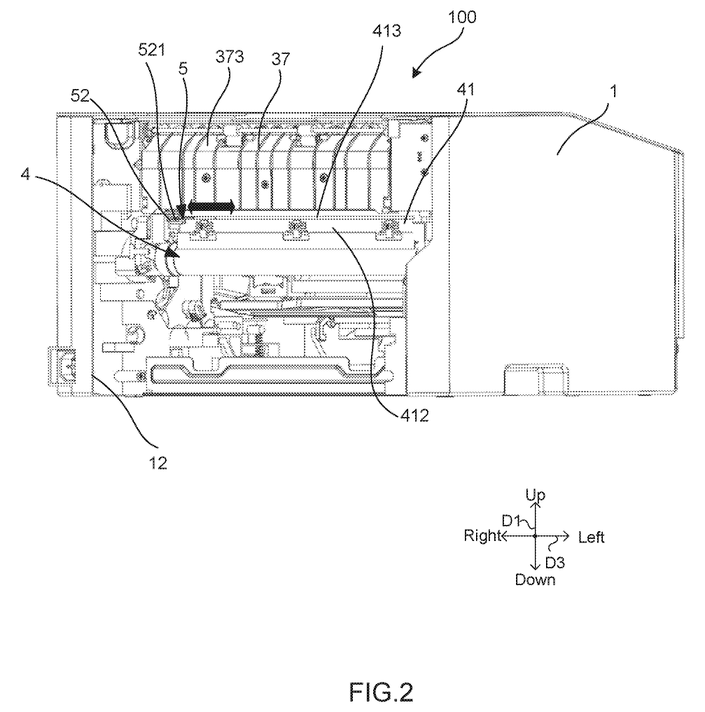

In the present embodiment, the image forming apparatus 100 further includes a cover 11. The cover 11 is a member that opens and closes an opening 12 (refer to FIG. 2) through which a photoconductor unit 4 in the apparatus body 1 is exposed externally. Specifically, the cover 11 has a rectangular shape, as viewed from the front-and-back direction D2, and is provided on a back side of the apparatus body 1. The cover 11 opens and closes the opening 12 having a rectangular shape and being provided on the back side of the apparatus body 1. Note that the opening 12 is not limited to being provided on the back side of the apparatus body 1, and may be provided, for example, to the front of (on a front side of) the apparatus body 1. In this case, the cover 11 is mounted to open and close the opening 12 in the front of the apparatus body 1. Further, the opening 12 may be provided on a left side or a right side of the apparatus body 1. In this case, the cover 11 is mounted to open and close the opening 12 on the left side or the right side of the apparatus body 1.

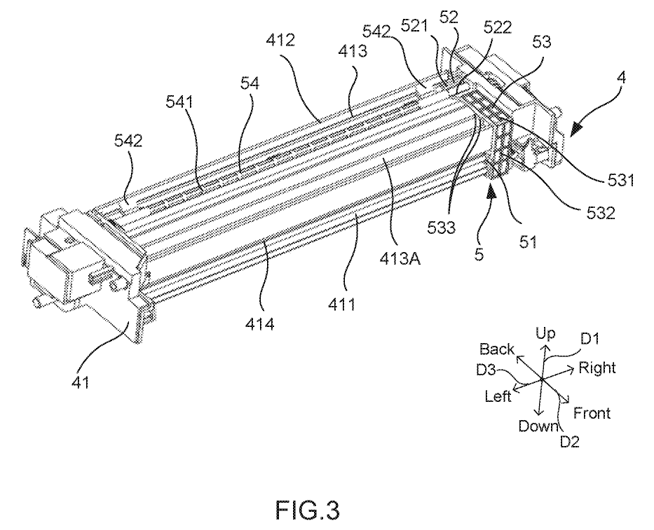

Here, the photoconductor unit 4 is a unit that is accommodated in the apparatus body 1 and that includes the photoconductor 31 having a surface on which an electrostatic latent image is to be formed, and the charging apparatus 32 charging the surface of the photoconductor 31. The photoconductor unit 4 is a single unit obtained by incorporating the photoconductor 31 and the charging apparatus 32 into a unit body 41 (refer to FIG. 3). In the present embodiment, the photoconductor unit 4 is the single unit further including the development apparatus 34, the cleanup apparatus 36, the toner container, and a cleaning apparatus 5 described later in addition to the photoconductor 31, the charging apparatus 32, and the transfer apparatus 35.

As illustrated in FIG. 1, a lower end of the cover 11 is mounted on a lower end on the back side of the apparatus body 1, and the cover 11 can be rotated about the lower end on the back side of the apparatus body 1 clockwise or counterclockwise, as viewed from the right-and-left direction D3. Further, a lock member (not illustrated) is provided to an upper end of the cover 11. In a state in which the cover 11 is closed, the lock member is coupled to a locked portion (not illustrated) that is provided on an upper side of the opening 12 on the back side of the apparatus body 1. This results in the opening 12 remaining closed by the cover 11. It is only required that a user perform operation of decoupling the lock member from the locked portion in order to open the cover 11.

When the cover 11 is closed, the opening 12 provided on the back side of the apparatus body 1 is covered with the cover 11, as illustrated in <Cover: closed> of FIG. 1. On the other hand, when the cover 11 is open, the cover 11 is rotated counterclockwise about the lower end on the back side of the apparatus body 1 so that the opening 12 is exposed externally, as illustrated in <Cover: open> of FIG. 1.

Here, for example, some of the transportation rollers 23 and the transfer apparatus 35 are mounted on the cover 11. Thus, some of the transportation rollers 23 and the transfer apparatus 35 are separated from the photoconductor unit 4 when the cover 11 is open, as illustrated in <Cover: open> of FIG. 1. As a result, the photoconductor unit 4 is exposed externally through the opening 12. Thus, when the cover 11 is open, a user can access the photoconductor unit 4 exposed externally through the opening 12, as illustrated in FIG. 2. Further, when the cover 11 is open, the user can, for example, remove the photoconductor unit 4 from the apparatus body 1 and attach the photoconductor unit 4 to the apparatus body 1.

By the way, a cleaning member that cleans a wire electrode is known as a related technology. The wire electrode is included in a charging device, and produces a corona discharge in order to charge a photoconductor of an image forming apparatus. With respect to the related technology described above, the cleaning member is reciprocally moved in a longitudinal direction of an opening of the charging device when the wire electrode of the charging device is cleaned. This results in cleaning the wire electrode sandwiched between cleaning pads of the cleaning member.

Here, in order to clean a wire electrode of a charging device (a charging apparatus) using the related technology described above, a photoconductor unit including the charging apparatus and a photoconductor is removed from an apparatus body, and a cleaning member is operated in a state in which the photoconductor unit is placed on furniture such as a desk. In other words, when the wire electrode of the charging apparatus is cleaned using the related technology described above, the wire electrode is not cleaned if a user does not remove the photoconductor unit from the apparatus body. Thus, it is necessary for the user to work on a plurality of tasks including removing the photoconductor unit and cleaning the wire electrode. As a result, the cleaning operation tends to be troublesome for the user.

Note that, when the photoconductor unit is placed on furniture, there is a need to take measures to protect the photoconductor, such as covering the photoconductor with a protection member or forming the photoconductor unit into a shape that enables the photoconductor to not be brought into contact with the top of a desk. Thus, the photoconductor unit is easily made relatively large in size due to the above-described measures being taken. Further, the apparatus body is also made larger in size when the photoconductor unit is made larger in size.

On the other hand, the present embodiment provides a configuration described below that makes it possible to provide the cleaning apparatus 5 and image forming apparatus 100 in which the wire electrode 321 can be easily cleaned without removing, from the apparatus body 1, the photoconductor unit 4 including the charging apparatus 32 and the photoconductor 31. Specifically, the image forming apparatus 100 includes the apparatus body 1, the photoconductor unit 4, the cover 11, and the cleaning apparatus 5 described below. The cleaning apparatus 5 is an apparatus that cleans the wire electrode 321 of the charging apparatus 32.

### 2. Configuration of Cleaning Apparatus

The cleaning apparatus 5 according to the present embodiment is described in detail below with reference to the drawings. First, the reason to clean the wire electrode 321 is described briefly. When the wire electrode 321 is exposed to ozone generated due to corona discharge, oxide is generated on a surface of the wire electrode 321. Due to the oxide being attached to the surface of the wire electrode 321, the corona discharge is not produced uniformly, and thus the surface of the photoconductor 31 is not charged uniformly. Therefore, a coating process is performed on the surface of the wire electrode 321 in order to prevent oxide from being generated. However, oxide is generated on the surface of the wire electrode 321 due to a deterioration in coating over time. This results in there being a possibility that the surface of the photoconductor 31 will not be charged uniformly. Thus, it is desirable that the surface of the wire electrode 321 be cleanable using the cleaning apparatus 5.

As illustrated in FIGS. 3 to 5, the cleaning apparatus 5 includes a cleaning member 51, an operation member 52, a linkage member 53, and a restriction member 54.

The cleaning member 51 is a member that is brought into contact with the wire electrode 321 to clean the wire electrode 321. Specifically, the cleaning member 51 includes a cleaning pad (not illustrated) and a pair of holding parts 511.

The cleaning pad is made of, for example, sponge, felt, or nonwoven fabric. The cleaning pad is folded to be held by the pair of holding parts 511.

Holding parts 511 of the pair of holding parts 511 each have a length in the front-and-back direction D2, and are spaced from each other in the up-and-down direction D1 to be formed integrally with a second linkage part 532 (described later) of the linkage member 53. The folded cleaning pad is inserted between the holding parts 511 of the pair of holding parts 511. Thus, the pair of holding parts 511 holds the cleaning pad in a folded state.

As illustrated in FIG. 3, the pair of holding parts 511 holding the cleaning pad is inserted into a first groove 411 that is provided to the unit body 41 of the photoconductor unit 4. The first groove 411 is provided to a front portion of the unit body 41, and is a rearwardly recessed groove that has a length in the right-and-left direction D3. The wire electrode 321 in an exposed state is arranged in the first groove 411. Then, the wire electrode 321 arranged in the first groove 411 is sandwiched between portions of the cleaning pad inserted into the first groove 411 so that the cleaning pad is brought into contact with wire electrode 321. In this state, the cleaning member 51 moves in a length direction of the wire electrode 321 (here, the right-and-left direction D3) to cause the cleaning pad to move while sliding on the surface of the wire electrode 321, and the cleaning pad removes extraneous material (such as oxide) attached to the surface of the wire electrode 321.

The operation member 52 is exposed to the exterior of the apparatus body 1 of the image forming apparatus 100 through the opening 12 through which the photoconductor unit 4 is exposed externally. Specifically, the operation member 52 is exposed to the exterior of the apparatus body 1 in a state in which the cover 11 opening and closing the opening 12 is open. Then, the operation member 52 moves the cleaning member 51 in the length direction of the wire electrode 321 (here, the right-and-left direction D3) in response to operation being externally performed by a user. The operation member 52 includes an operation part 521 and a guide part 522.

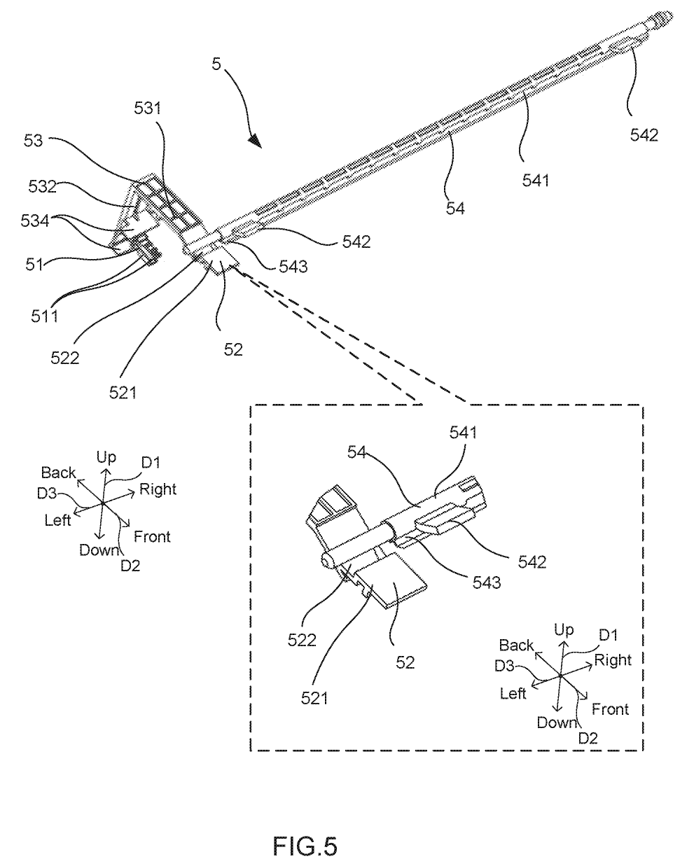

As illustrated in FIG. 5, the operation part 521 has a rectangular-plate shape, and is a portion of the operation member 52 that is taken by a user with his/her fingers. In FIG. 5, a portion surrounded by a dashed line is an enlarged portion around the operation part 521. As illustrated in FIGS. 2 and 3, a portion of the operation part 521 is externally exposed through a slit 413 that is provided to a support wall 412 of the unit body 41 of the photoconductor unit 4. The support wall 412 is a rectangle-shaped wall that has a length in the right-and-left direction D3, and supports the operation part 521 inserted into the slit 413, such that the operation part 521 can be moved in the right-and-left direction D3. The slit 413 has a rectangular shape, as viewed from the front-and-back direction D2, and a length direction of the slit 413 (here, the right-and-left direction D3) substantially coincides with the length direction of the wire electrode 321. Further, the slit 413 has a length nearly equal to the length of the wire electrode 321 (here, the length in the right-and-left direction D3). Thus, a user can move the operation part 521 in the length direction of the slit 413 by taking the externally exposed operation part 521 with his/her fingers.

As illustrated in FIG. 5, the guide part 522 is a plate member that extends rearward from a back end of the operation part 521, and is a portion that guides the restriction member 54 described later. As illustrated in FIG. 5, a front end of the guide part 522 is situated lower than the back end of the operation part 521, and the guide part 522 is formed to be inclined upward from the front end to a back end of the guide part 522. Thus, a middle portion of the guide part 522 is formed to be recessed downward, and an axial body 541 (described later) of the restriction member 54 is situated in the middle portion. Further, the guide part 522 is formed to have a shape that enables a lateral end (here, a right end) of the guide part 522 to be brought into contact with a hook part 543 (described later) of the restriction member 54 when the guide part 522 is moved together with the operation part 521 in the right-and-left direction D3. Thus, the guide part 522 is moved together with the operation part 521 in the right-and-left direction D3 to push the hook part 543 upward such that the axial body 541 is axially rotated together with the hook part 543.

The linkage member 53 is connected to each of the operation member 52 and the cleaning member 51, and is a member that moves the cleaning member 51 due to the operation member 52 being moved in response to being operated externally. Here, in the present embodiment, the wire electrode 321 is situated on an opposite side of a portion of the photoconductor unit 4 from the operation member 52. Specifically, the wire electrode 321 is situated in front of the photoconductor 31, as illustrated in FIG. 4. Thus, as in the case of the wire electrode 321, the cleaning member 51 cleaning the wire electrode 321 is situated in front of the photoconductor 31, that is, on the opposite side of the portion of the photoconductor unit 4 from the operation member 52. On the other hand, the operation member 52 is situated behind the photoconductor unit 4, that is, behind the photoconductor 31, as illustrated in FIG. 2. As described above, the operation member 52 and the cleaning member 51 are arranged away from each other, with the photoconductor 31 being situated between the operation member 52 and the cleaning member 51.

Thus, in the present embodiment, the cleaning apparatus 5 includes the linkage member 53 in order to cause the operation member 52 and cleaning member 51 situated away from each other to work together. As a result, the cleaning member 51 situated away from the operation member 52 can be moved together with the operation member 52 through the linkage member 53 when a user performs an operation of moving the operation member 52. This makes it possible to clean the wire electrode 321 using the cleaning member 51.

As illustrated in FIGS. 3 and 5, the linkage member 53 includes a first linkage part 531 and the second linkage part 532.

The first linkage part 531 has a rectangular-plate shape, as viewed from the up-and-down direction D1, and has a length in the front-and-back direction D2. The first linkage part 531 is formed such that a front end of the first linkage part 531 is integral with the back end of the guide part 522 of the operation member 52. Guide protrusions 533 of a pair of guide protrusions 533 each protruding downward are spaced from each other in the front-and-back direction D2 to be formed integrally with a lower surface in a middle portion of the first linkage part 531. An upper end of a guide wall 413A (refer to FIG. 3) that is provided to the unit body 41 of the photoconductor unit 4 is inserted between the guide protrusions 533 the pair of guide protrusions 533. The guide wall 413A is a rectangle-shaped wall that has a length in the right-and-left direction D3, and protrudes upward from an upper portion of the unit body 41. As a result, in a state of being movable in the right-and-left direction D3, the first linkage part 531 is supported by the guide wall 413A in the upper portion of the unit body 41.

The second linkage part 532 has a rectangular-plate shape, as viewed from the front-and-back direction D2, and has a length in the up-and-down direction D1. The second linkage part 532 is formed such that an upper end of the second linkage part 532 is integral with a back end of the first linkage part 531. Guide protrusions 534 of a pair of guide protrusions 534 each protruding rearward are spaced from each other in the up-and-down direction D1 to be formed integrally with a back surface in a lower end portion of the second linkage part 532. Further, the holding parts 511 of the pair of holding parts 511 of the cleaning member 51 each protrude rearward to be formed integrally between the guide protrusions 534 of the pair of guide protrusions 534 on the back surface of the second linkage part 532.

One of the pair of support protrusions 534 that is situated at a higher position is inserted into a second groove 414 (refer to FIG. 3) that is provided to the unit body 41 of the photoconductor unit 4. The second groove 414 is provided higher than the first groove 411 in the front portion of the unit body 41, and is a rearwardly recessed groove that has a length in the right-and-left direction D3. Further, another of the pair of support protrusions 534 that is situated at a lower position includes an upper surface that is in contact with a lower surface of the unit body 41. As a result, in a state of being movable in the right-and-left direction D3, the second linkage part 532 is supported by the unit body 41 in the front portion of the unit body 41. Thus, in a state of being movable in the right-and-left direction D3, the linkage member 53 is supported by the unit body 41 by each of the first linkage part 531 and the second linkage part 532 being supported by the unit body 41.

In the cleaning apparatus 5 according to the present embodiment, the operation member 52 is externally exposed through the opening 12 of the apparatus body 1, as described above. Then, the cleaning member 51 is moved by the operation member 52 being externally operated. This makes it possible to clean the wire electrode 321. This provides an advantage in that a user can easily clean the wire electrode 321 without removing the photoconductor unit 4 including the charging apparatus 32 and the photoconductor 31 from the apparatus body 1. This also provides an advantage in that the cleaning operation is less likely to be troublesome for the user since there is no need to remove the photoconductor unit 4 upon cleaning the wire electrode 321.

Further, in the present embodiment, there is no need to place the photoconductor unit 4 on furniture upon cleaning the wire electrode 321, as in the case of the related technology described above. This results in there being no need to take measures to protect the photoconductor 31, such as covering the photoconductor 31 with a protection member or forming the photoconductor unit 4 into a shape that enables the photoconductor 4 to not be brought into contact with the top of a desk. This provides an advantage in that the photoconductor 4 can be easily made smaller in size and the apparatus body 1 can also be easily made smaller in size, compared to when there is a need for the measures described above.

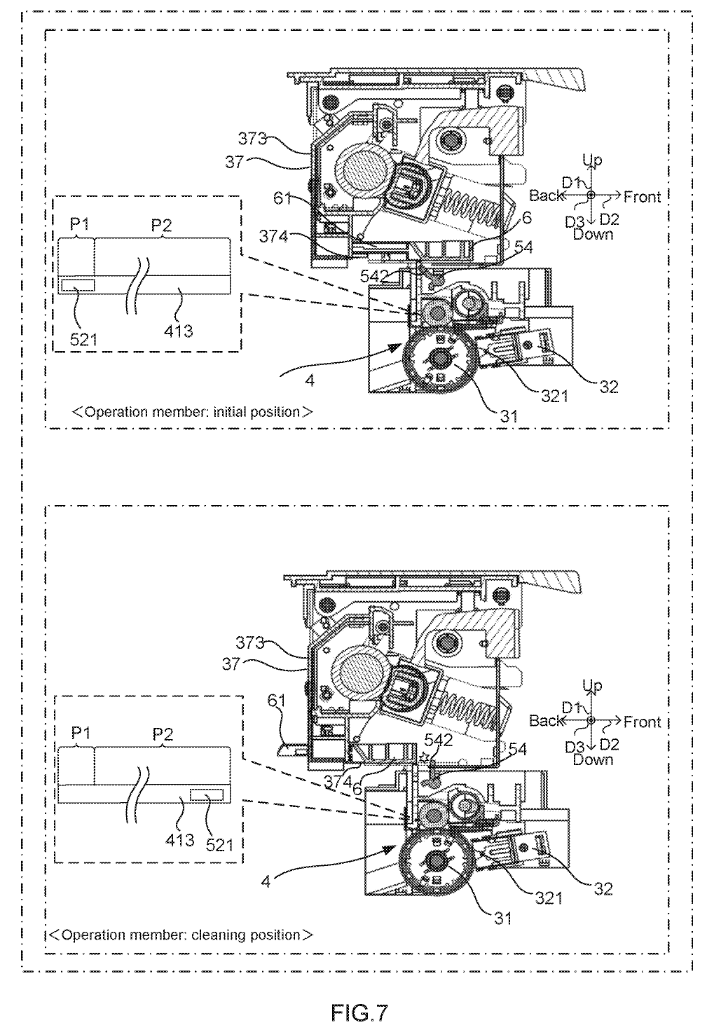

The restriction member 54 is a member that restricts, when the operation member 52 is at a cleaning position P2, movement of the cover 11 in a direction of closing the opening 12. Here, in response to being operated externally, the operation member 52 can be moved between an initial position P1 and the cleaning position P2 different from the initial position P1 (refer to FIG. 7).

As illustrated in FIGS. 2, 5, and 7, the initial position P1 is a position of an end (here, a left end) of a movable range for the operation member 52 in the right-and-left direction D3. In FIG. 7, portions surrounded by dashed lines are portions used to describe a position of the operation part 521 of the operation member 52. At the initial position P1, the operation part 521 of the operation member 52 faces an end (here, a left end) of the axial body 541 of the restriction member 54. The initial position P1 is, for example, a position at which the cleaning member 51 does not face the surface of the photoconductor 31 in the movable range for the operation member 52 (that is, a movable range for the cleaning member 51). The initial position P1 is a position at which the cleaning member 51 is least likely to have an impact on charging of the surface of the photoconductor 31 when the wire electrode 321 charges the surface of the photoconductor 31.

On the other hand, the cleaning position P2 is, for example, a position at which the cleaning member 51 faces the surface of the photoconductor 31 in the movable range for the operation member 52 (that is, the movable range for the cleaning member 51), as illustrated in FIG. 7. The cleaning position P2 is a position at which the cleaning member 51 is more likely to have an impact on charging of the surface of the photoconductor 31 when the wire electrode 321 charges the surface of the photoconductor 31. Thus, the surface of the photoconductor 31 is more likely to be charged ununiformly when the operation member 52 is at the cleaning position P2. This may result in defects in an image formed on the sheet Sh1.

Thus, in the present embodiment, the restriction member 54 is included in the cleaning apparatus 5. As a result, the cover 11 is allowed to be closed only when the operation member 52 is at the initial position P1, and the cover 11 is not closed when the operation member 52 is at the cleaning position P2. Accordingly, when the operation member 52 is at the cleaning position P2, the cover 11 is not closed, and thus the image forming apparatus 100 is not operated. This provides an advantage in that occurrence of defects in an image formed on the sheet Sh1 is easily prevented beforehand.

The restriction member 54 is described in detail below with reference to the drawings. As illustrated in FIGS. 3 to 5, the restriction member 54 includes the axial body 541, a pair of protrusions 542, the hook part 543, and a biasing member 544.

The axial body 541 has a round-bar shape, and has a length in the right-and-left direction D3. Two ends of the axial body 541 in a length direction of the axial body 541 (here, the right-and-left direction D3) are mounted on the unit body 41 of the photoconductor unit 4, with the axial body 541 being axially movable clockwise or counterclockwise.

Protrusions 542 of the pair of protrusions 542 are rectangular-plate-shaped members that each protrude radially outwardly from an outer peripheral surface of the axial body 541. The protrusions 542 of the pair of protrusions 542 are respectively formed integrally with the two ends of the axial body 541 in the length direction of the axial body 541 (here, the right-and-left direction D3).

The hook part 543 protrudes radially outwardly from the outer peripheral surface of the axial body 541, and is formed integrally with the axial body 541 across the axial body 541 in the length direction of the axial body 541 (here, the right-and-left direction D3). The hook part 543 is situated lower than the pair of protrusions 542 when the guide part 522 of the operation member 52 is not in contact with the hook part 543. When the operation part 521 is situated at the cleaning position P2 by being moved from the initial position P1, the hook part 543 is pushed upward by the guide part 522 to be rotated counterclockwise.

The biasing member 544 is, for example, a torsion coil spring, and, when the hook part 543 remains rotated counterclockwise by being pushed upward by the guide part 522, the biasing member 544 is compressed to accumulate elastic energy. Then, when the hook part 543 becomes out of contact with the guide part 522, the biasing member 544 releases the accumulated elastic energy to rotate the axial body 541 clockwise.

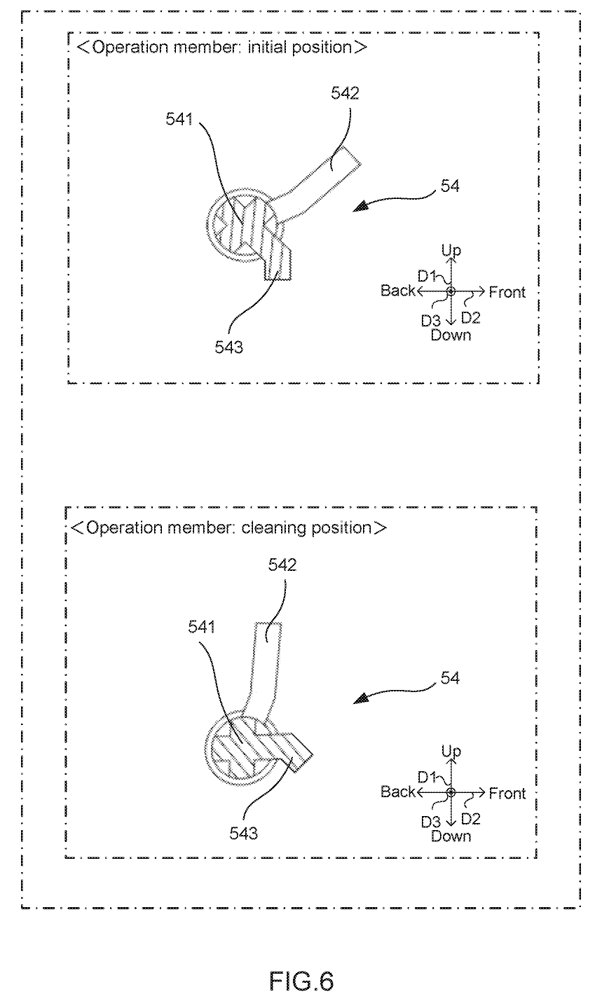

Here, when the hook part 543 is pushed upward by the guide part 522 to be rotated, the axial body 541 and the pair of protrusions 542 are rotated together with the hook part 543, as illustrated in FIG. 6. Thus, when the operation member 52 is at the initial position P1, that is, when the hook part 543 is not in contact with the guide part 522, each of the protrusions 542 of the pair of protrusions 542 is in a position given in <Operation member: initial position> of FIG. 6. This position is hereinafter also referred to as an "allowable position." Further, when the operation member 52 is at the cleaning position P2, that is, when the hook part 543 is pushed upward by the guide part 522, each of the protrusions 542 of the pair of protrusions 542 is counterclockwise up to a position given in <Operation member: cleaning position> of FIG. 6. This position is hereinafter also referred to as a "restriction position." In this case, the biasing member 544 is compressed to accumulate elastic energy.

Thereafter, when the operation member 52 is moved from the cleaning position P2 to the initial position P1, the guide part 522 is separated from the hook part 543. Then, the biasing member 544 releases the accumulated elastic energy to rotate the axial body 541 clockwise. As a result, the hook part 543 is also rotated clockwise, and the restriction member 54 returns to the allowable position from the restriction position.

In the present embodiment, the restriction member 54 restricts movement of a shutter 6 (refer to FIG. 7) to provide a function to limit closing of the opening 12 with the cover 11. Here, the shutter 6 is a member that shuts off a heat source (here, the heater of the fixation apparatus 37) in the apparatus body 1 from the exterior of the apparatus body 1 when the cover 11 is open. Specifically, the shutter 6 is a member that closes an opening 374 that is provided to a lower surface of a case 373 of the fixation apparatus 37, as illustrated in FIG. 7. The opening 374 is a portion of a transportation path used to transport, to the fixation apparatus 37, the sheet Sh1 onto which a toner image is transferred by the transfer apparatus 35. The shutter 6 is provided to prevent a user from touching the heater (a heat source) in the case 373 of the fixation apparatus 37 by accident in the process of working on overcoming of a jam (a paper jam) of the sheet Sh1 upon, for example, occurrent of the jam.

At a back end of the shutter 6, a rearwardly extending bar-shaped protrusion 61 is formed integrally with the shutter 6, as illustrated in FIG. 7. When the cover 11 is closed, the protrusion 61 is pushed forward by the cover 11 to be moved forward together with the shutter 6. This results in the shutter 6 being accommodated in the case 373 of the fixation apparatus 37 when the cover 11 is closed. In this state, the opening 374 provided to the lower surface of the case 373 of the fixation apparatus 37 is not closed by the shutter 6.

Further, the shutter 6 includes a biasing member (not illustrated) that biases the shutter 6 in a direction in which the shutter 6 is moved rearward. The biasing member is, for example, a coil spring, and, when the shutter 6 is accommodated in the case 373 of the fixation apparatus 37, the biasing member is compressed by being pushed forward by the cover 11 through the shutter 6 and the protrusion 61, and accumulate elastic energy. Then, when the cover 11 is opened, force with which the biasing member is pushed through the shutter 6 and the protrusion 61 is lost. The biasing member releases the accumulated elastic energy to move the shutter 6 rearward. As a result, when the cover is open, the shutter 6 closes the opening 374 provided to the lower surface of the case 373 of the fixation apparatus 37 to shut off the heat source (the heater) from the exterior of the apparatus body 1.

Here, as given in <Operation member: initial position> of FIG. 7, the protrusion 61 does not protrude outward from the opening 12 when the shutter 6 is accommodated in the case 373 of the fixation apparatus 37. Thus, the cover 11 can be closed. A position at which the shutter 6 is accommodated in the case 373 of the fixation apparatus 37 is hereinafter also referred to as a first position at which the shutter 6 does not prevent movement of the cover 11 in a direction of closing the opening 12. On the other hand, as given in <Operation member: cleaning position> of FIG. 7, the protrusion 61 protrudes outward from the opening 12 when the opening 374 provided to the lower surface of the case 373 of the fixation apparatus 37 is closed by the shutter 6. Thus, when this state is maintained, the protrusion 61 restricts movement of the cover 11 in a direction of closing the cover 11 even if a user tries to close the cover 11. Thus, the cover 11 is not closed. A position at which the shutter 6 closes the opening 374 provided to the lower surface of the case 373 of the fixation apparatus 37 is hereinafter also referred to as a second position at which the shutter 6 prevents the movement of the cover 11 in the direction of closing the opening 12.

The function of the restriction member 54 is described in detail below. When the operation member 52 is at the initial position P1, the restriction member 54 is in the allowable position, as given in <Operation member: initial position> of FIG. 6. In this case, the pair of protrusions 542 does not protrude into the case 373 of the fixation apparatus 37, as given in <Operation member: initial position> of FIG. 7. Thus, the shutter 6 can be moved without being restricted by the pair of protrusions 542. As a result, when a user wants to close the cover 11 in a state in which the cover 11 is open, the protrusion 61 is pushed by the cover 11 to move the shutter 6 from the first position to the second position. In other words, the allowable position is a position in which the restriction member 54 allows movement of the shutter 6 from the second position to the first position.

On the other hand, when the operation member 52 is at the cleaning position P2, the restriction member 54 is in the restriction position, as given in <Operation member: cleaning position> of FIG. 6. In this case, the pair of protrusions 542 protrudes into the case 373 of the fixation apparatus 37, as given in <Operation member: cleaning position> of FIG. 7. Thus, movement of the shutter 6 is restricted by the pair of protrusions 542. As a result, when the restriction member 54 is in the restriction position in a state in which the cover 11 is open, movement of the shutter 6 from the second position to the first position is restricted by the pair of protrusions 542 even if a user tries to close the cover 11. Thus, even if the user tries to close the cover 11, the cover 11 is not closed since the protrusion 61 restricts movement of the cover 11 in a direction in which the cover 11 is closed. In other words, the restriction position is a position in which the restriction member 54 restricts movement of the shutter 6 from the second position to the first position.

As described above, the restriction member 54 can be moved between the restriction position and the allowable position due to movement of the operation member 52. In the restriction position, the restriction member 54 restricts movement of the shutter 6 from the second position to the first position, and in the allowable position, the restriction member 54 allows the movement of the shutter 6 from the second position to the first position. Further, the restriction member 54 is in the restriction position when the operation member 52 is at the cleaning position P2, and the restriction member 54 is in the allowable position when the operation member 52 is at the initial position P1. Thus, the cover 11 can be closed only when the operation member 52 is at the initial position P1, and the cover is not closed when the operation member 52 is at the cleaning position P2. This provides an advantage in that a user does not easily forget to return the operation member 52 to the initial position P1. Further, when the operation member 52 is at the cleaning position P2, the cover 11 is not closed, and thus the image forming apparatus 100 is not operated. This provides an advantage in that occurrence of defects in an image formed on the sheet Sh1 is easily prevented beforehand.

### 3. Modifications

In the embodiment described above, the linkage member 53 is formed integrally with the operation member 52 and the cleaning member 51, although the linkage member 53 is not limited thereto. For example, the linkage member 53 may be formed independently of the operation member 52 and cleaning member 51 and fixed to each of the operation member 52 and the cleaning member 51 using a fixation method such as bonding.

In the embodiment described above, the cleaning apparatus 5 includes the linkage member 53. However, the cleaning apparatus 5 does not necessarily have to include the linkage member 53. For example, it is only required that the cleaning apparatus 5 include the operation member 52 and the cleaning member 51 and that the cleaning member 51 be configured to be movable in response to the operation member 52 being operated. As an example, the operation member 52 and the cleaning member 51 may be electrically or magnetically coupled to each other, and the cleaning member 51 may be movable due to movement of the operation member 52.

In the embodiment described above, the restriction member 54 restricts movement of the shutter 6 to restrict movement of the cover 11 in a direction of closing the opening 12, although the restriction member 54 is not limited thereto. For example, the restriction member 54 may be configured to be accommodated in the apparatus body 1 when the operation member 52 is at the initial position P1 and to protrude outward from the opening 12 when the operation member 52 is at the cleaning position. In this case, when the operation member 52 is at the cleaning position, the restriction member 54 can restrict, by directly interfering with the cover 11, the movement of the cover 11 in the direction of closing the opening 12.

In the embodiment described above, the cleaning apparatus 5 includes the restriction member 54. However, the cleaning apparatus 5 does not necessarily have to include the restriction member 54. In this case, the cover 11 can also be closed when the operation member 52 is at the cleaning position P2. Further, in this case, when the image forming apparatus 100 includes, for example, a sensor that detects whether the operation member 52 is at the initial position P1, a message or the like indicating that the operation member 52 is not at the initial position P1 may be displayed on the operation display section according to a result of the detection performed by the sensor. This enables a user to easily grasp that the operation member 52 has not returned to the initial position P1.

### Appendixes of Disclosure

A summary of the disclosure that is extracted from the embodiments described above is appended below. Note that configurations and processing functions that are described in appendixes described below may be selected to be combined discretionarily.

### Appendix 1

A cleaning apparatus that cleans a wire electrode of a charging apparatus that charges a surface of a photoconductor, with an electrostatic latent image being to be formed on the surface, the cleaning apparatus including:

a cleaning member that is brought into contact with the wire electrode to clean the wire electrode; and

an operation member that is exposed to an exterior of an apparatus body of an image forming apparatus through an opening through which a photoconductor unit that includes the photoconductor and the charging apparatus is exposed externally, the operation member moving the cleaning member in a length direction of the wire electrode in response to being operated from the exterior.

### Appendix 2

The cleaning apparatus according to appendix 1, in which

the cleaning member is situated on an opposite side of a portion of the photoconductor unit from the operation member, and

the cleaning apparatus further includes a linkage member that is connected to each of the operation member and the cleaning member, the linkage member moving the cleaning member due to the operation member being moved in response to being operated from the exterior.

### Appendix 3

The cleaning apparatus according to appendix 1 or 2, in which

the image forming apparatus includes a cover that opens and closes the opening,

in response to being operated from the exterior, the operation member is movable between an initial position and a cleaning position that is different from the initial position, and

the cleaning apparatus further includes a restriction member that restricts, when the operation member is at the cleaning position, movement of the cover in a direction of closing the opening.

### Appendix 4

The cleaning apparatus according to appendix 3, in which

the image forming apparatus includes a shutter that shuts off a heat source in the apparatus body from the exterior when the cover is open,

the shutter is movable between a first position and a second position, the first position being a position at which the shutter does not prevent the movement of the cover in the direction of closing the opening, the second position being a position at which the shutter prevents the movement of the cover in the direction of closing the opening,

the restriction member is movable between a restriction position and an allowable position due to the movement of the operation member, the restriction position being a position in which the restriction member restricts movement of the shutter from the second position to the first position, the allowable position being a position in which the restriction member allows the movement of the shutter from the second position to the first position, and

the restriction member is in the restriction position when the operation member is at the cleaning position, and is in the allowable position when the operation member is at the initial position.

### Appendix 5

An image forming apparatus, including:

the cleaning apparatus according to any one of appendixes 1 to 4;

the apparatus body; and

the photoconductor unit.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A cleaning apparatus that cleans a wire electrode of a charging apparatus that charges a surface of a photoconductor, with an electrostatic latent image being to be formed on the surface, the cleaning apparatus comprising:
a cleaning member that is brought into contact with the wire electrode to clean the wire electrode; and
an operation member that is exposed to an exterior of an apparatus body of an image forming apparatus through an opening through which a photoconductor unit that includes the photoconductor and the charging apparatus is exposed externally, the operation member moving the cleaning member in a length direction of the wire electrode in response to being operated from the exterior.

2. The cleaning apparatus according to claim 1, wherein
the cleaning member is situated on an opposite side of a portion of the photoconductor unit from the operation member, and
the cleaning apparatus further comprises a linkage member that is connected to each of the operation member and the cleaning member, the linkage member moving the cleaning member due to the operation member being moved in response to being operated from the exterior.

3. The cleaning apparatus according to claim 1, wherein
the image forming apparatus includes a cover that opens and closes the opening,
in response to being operated from the exterior, the operation member is movable between an initial position and a cleaning position that is different from the initial position, and
the cleaning apparatus further comprises a restriction member that restricts, when the operation member is at the cleaning position, movement of the cover in a direction of closing the opening.

4. The cleaning apparatus according to claim 3, wherein
the image forming apparatus includes a shutter that shuts off a heat source in the apparatus body from the exterior when the cover is open,
the shutter is movable between a first position and a second position, the first position being a position at which the shutter does not prevent the movement of the cover in the direction of closing the opening, the second position being a position at which the shutter prevents the movement of the cover in the direction of closing the opening,
the restriction member is movable between a restriction position and an allowable position due to the movement of the operation member, the restriction position being a position in which the restriction member restricts movement of the shutter from the second position to the first position, the allowable position being a position in which the restriction member allows the movement of the shutter from the second position to the first position, and
the restriction member is in the restriction position when the operation member is at the cleaning position, and is in the allowable position when the operation member is at the initial position.

5. An image forming apparatus, comprising:
the cleaning apparatus according to claim 1;
the apparatus body; and
the photoconductor unit.
